(19) United States
(12) Patent Application Publication
(10) Pub. No.: US 2020/0242973 A1
(43) Pub. Date: Jul. 30, 2020

(54) ANATOMICAL STRUCTURE MODEL AND COMPONENTS FOR USE IN TRAINING SURGICAL PROCEDURES

(71) Applicant: Simmo3D, LLC, Temple, TX (US)

(72) Inventors: Colin Reed Dodson, Austin, TX (US); Ryan Taylor Quinn, Austin, TX (US)

(73) Assignee: Simmo3D, LLC, Temple, TX (US)

(21) Appl. No.: 16/261,550

(22) Filed: Jan. 29, 2019

(51) Int. Cl. G09B 23/30; G09B 23/34

(52) U.S. Cl. CPC G09B 23/303; G09B 23/34

(57) ABSTRACT

An anatomical structure model includes a first component defining a first part of the anatomical structure and a second component defining a second part of the anatomical structure. Each of the first and second components define a respective opening and the two components are adapted to be placed in an assembled position to define an insert receiving passage between the first component and the second component. An insert of the model includes an insert peripheral edge structure extending around a periphery thereof, and is adapted to be received in an operating position between the first component and the second component. A connector arrangement detachably connects the first component and the second component in the assembled position with the insert in the operating position.

### TECHNICAL FIELD OF THE INVENTION

The invention relates to anatomical structure models and modeling systems and methods especially adapted for use as training aids. The invention also encompasses an expendable anatomical structure model insert which cooperates with other components of the model to provide the desired simulation and which may be readily replaced after use.

### BACKGROUND OF THE INVENTION

Models of various anatomical structures have long been used as teaching aids in general education and in medical education. More recently, anatomical structure models have been developed for us in training physicians to perform various medical procedures. For example, medical procedures involving the human heart may be simulated using a model of the heart or at least the portions of heart involved in the given procedure. U.S. Pat. No. 7,220,127 provides an example of a heart model which may be used in connection with training relating to lead implantation within the heart. This patent discloses a model including the right atrium and right ventricle of the heart together with the superior vena cava leading to the right atrium. The model facilitates training for procedures in which a catheter is inserted through the superior vena cava and into the right atrium and/or right ventricle to implant a device, such as a lead, at a desired location. The heart model disclosed in U.S. Pat. No. 7,220,127 includes replaceable plugs of soft material which can be inserted into openings at various locations in the model where implantation is desired. Each plug is formed from a soft material and provides a surface within the model which is intended to allow the desired device to be affixed.

The model and replaceable plug arrangement shown in U.S. Pat. No. 7,220,127 is of limited use as a training aid for a number of reasons. For example, because the replaceable plugs necessarily extend through an opening in the model and protrude into the respective heart chamber, they cannot provide a realistic representation of the heart structure as observed from within the chamber. Additionally, the replaceable plug shown in U.S. Pat. No. 7,220,127 is inserted through an opening in an exterior wall of the model, and there is no provision for placing such plugs within any part of the heart concealed within the interior of the structure. It is also apparent that the plugs disclosed in U.S. Pat. No. 7,220,127 cannot provide a realistic representation of any part of the heart concealed within the heart model because the plug material would necessarily protrude unnaturally from any surface in which a plug receiving opening is formed.

U. S. Patent Application Publication 2013/0288218 discloses generating a heart model from 3D CAD files produced from patient CT (computed tomography) scans, and then using the heart model to simulate a procedure in which a catheter is inserted into a chamber of the heart. CT scans used to produce a model may be selected from patients exhibiting an anatomical variation which may be implicated in the procedure to be simulated. This selection by anatomical variation is intended to provide a more realistic simulation.

Although producing an anatomical structure for modeling purposes from CT scans or otherwise developed 3D CAD files provides the potential benefit of allowing accurate modeling for a given anatomical variation or even of customizing a simulation model from data for a given patient, there remain problems with providing a realistic training simulation using models produced in this fashion. Among these problems is the difficulty of producing an anatomical model which will provide a desired simulation of the various tissues included in the anatomical structure. While manufacturing from 3D CAD files may allow relatively rapid production of dimensionally accurate models of anatomical structures, the materials from which the models may be manufactured may not exhibit the physical characteristics of the anatomical tissues in the structure, at least in certain areas of the model. Furthermore, for surgical procedure simulations in which areas of the model may be damaged, a model produced as described in 2013/0288218, for example, cannot be reused for additional simulations. Rather, a new model must be produced for each simulation.

### SUMMARY OF THE INVENTION

It is an object of the invention to provide a model of an anatomical structure which facilitates a realistic simulation for medical procedures involving the anatomical structure. Another object of the invention is to provide a readily replaceable and customizable insert for an anatomical structure model. A further object of the invention is to provide a heart modeling system with a readily replaceable and customizable insert which includes an anatomical feature representing a target for a particular medical procedure simulation.

An anatomical structure model according to one aspect of the present invention includes a first component comprising a first part of the anatomical structure and a second component defining a second part of the anatomical structure. Each of the first and second components define a respective opening and the two components are adapted to be placed together in an assembled position in which the second component opening at least partially aligns with the first component opening to define an insert receiving passage between the first component and the second component. A model according to this aspect of the invention further includes an insert which includes an insert peripheral edge structure extending around a periphery of the insert, and is adapted to be received in an operating position at least partially covering the insert receiving passage between the first component and the second component. A model according to this aspect of the invention further includes a connector arrangement for detachably connecting the first component and the second component in the assembled position with the insert in the operating position.

The combination of the two components forming two parts of the anatomical structure and the connector arrangement together with the insert according to this first aspect of the invention provides a number of advantages. Among these is the advantage that the insert may be readily replaced even though it is contained within the interior of the modeled structure. This ability to be replaced allows the insert to be expendable in the sense that it may be used and damaged in the course of a simulated procedure and then replaced with an undamaged insert for another simulated procedure using the model. The ability of the insert to be replaced also allows the insert to be customized to account for anatomical variations or provide a simulation for a structure presented by a particular individual. An additional advantage is that the insert may be formed from a different material than the material used for the other components. This facilitates both production of the model and more realistic simulations using the completed model. With regard to production, the first and second anatomical components may be formed from materials that need only form an accurate representation of the internal surfaces of the anatomical structure being modeled and are not required to simulate any elastic or other mechanical tissue properties. Thus the first and second components are well suited for production via additive manufacturing such as 3D printing for example. With regard to providing more realistic simulations, the separation of the insert from other components of the model allows only a relatively small portion of the overall model to be formed from materials which simulate anatomical tissues without compromises (for properties such as rigidity for example) which might otherwise be necessary to produce the desired model. In other words, the separation of the insert from other components in the model allows the insert to be manufactured from materials providing the most realistic reaction in a given simulation while the remainder of the model may be manufactured from materials which provide an accurate anatomical model but do not necessarily have to respond to surgical tools in the same way the corresponding actual anatomic structure would respond.

Implementations of the invention according to the first aspect of the invention may include an anatomical target component located on the insert. The anatomical target component may be located within an area bounded by the insert peripheral edge structure so as to align with the insert receiving passage when the insert is in the operating position and the first component and second component are in the assembled position. Locating the anatomical target on the insert in this fashion places the anatomical target so as to face a desired one of the first and second components then the model is assembled. This is desirable because the anatomical component may be any anatomical feature which may be implicated in a given surgical procedure, that is, represent a target for some action in the procedure or represent a marker from which a target for the action may be identified in the course of the procedure.

In some implementations of the invention according to the first aspect of the invention, the anatomical structure comprises portions of a mammalian heart. In these implementations the first component may comprise a left atrium representation and the second component may comprise a right atrium representation. The insert may comprise a representation of a portion of the interatrial septum having a septum wall portion. The anatomical target component may comprise a representation of the fossa ovalis formed in the septum wall portion and adapted to face the right atrium representation when the insert is received in the operating position with the first component and the second component in the assembled position. These implementations are particularly suited for providing simulations of procedures involving transseptal puncture. Additional components may be included in these implementations to provide more realistic simulations. In particular, an inferior vena cava component may be included together with an inferior vena cava connector arrangement adapted to connect the inferior vena cava component to the right atrium component. One or more circulation ports may be connected to the inferior vena cava component to help facilitate circulation of blood simulating liquid through the model. Further circulation ports may be included to facilitate this desired circulation including a tricuspid valve circulation port connected to a tricuspid valve dome of the right atrium component, a pulmonary vein circulation port connected to the left atrium component, and a mitral valve circulation port connected to a mitral dome of the left atrium component.

Regardless of the particular anatomical structure being modeled, implementations according to the first aspect of the invention may include an arrangement for providing an improved seal between the insert and the insert receiving passage. These implementations may include a first rim structure extending around the periphery of the first component opening and a second rim structure extending around the periphery of the second component. The insert peripheral edge structure may be received in the operating position by being captured between the first rim structure and the second rim structure. One or both of the first rim structure and the second rim structure may be formed from a material having a relatively higher hardness, that is, a relatively higher Shore durometer value, than a material from which the insert peripheral edge structure is formed. This arrangement may allow the insert peripheral edge structure to deform between one or both of the rim structures to provide a robust liquid-tight seal.

Implementations according to the first aspect of the invention also facilitate a realistic model of the desired anatomical model. In particular, the manner in which the insert is held in the operating position in relation to the first and second component allows the insert to be configured with surfaces providing continuity with the surfaces defined by the first and second components. To provide this desired continuity, the insert may define a peripheral wall having a wall thickness approximately matching a thickness of the insert receiving passage about a periphery of the insert receiving passage when the insert is received in the operating position. The insert peripheral edge structure may then comprise a tab extending from the peripheral wall in position to be captured between the first and second components.

Anatomical structure models according the first aspect of the invention may also include a magnet-based connector arrangement to facilitate easy assembly and disassembly of the model. In these implementations the model may include three or more first side connecting magnets mounted on the first component in a spaced apart relationship about the first component opening. Three or more second side connecting magnets may be mounted on the second component in a spaced apart relationship about the second component opening, with each second side connecting magnet being mounted to align with a respective one of the first side connecting magnets in an attracting orientation when the first component and second component are in the assembled position. This arrangement of connecting magnets allows the first and second components of the model to be held together securely in the assembled position with the insert held in its operating position. To facilitate placement of the magnets without interfering with the realism of the model as viewed from inside the various chambers defined by the model, one or more of the first side connecting magnets or second side connection magnets, or both may be mounted on a respective non-anatomical protuberance extending from an exterior surface of the respective component. Although this connecting magnet mounting arrangement results in a model which is not realistic when viewed from the outside of the model, the surfaces defined on the inside of the model where the procedure to be simulated takes place may remain a realistic representation of the actual anatomical structure being modeled.

Another aspect of the invention encompasses a heart modeling system which includes a mammalian heart model according to the first aspect of the invention. In this case, the first component of the heart model comprises a representation of a first chamber of the heart and the second component comprises a representation of a second chamber of the heart. The insert in such a heart modeling system may include a portion of a wall between the first and second components. A modeling system according to this second aspect of the invention further includes a support base, a liquid reservoir, and a circulation arrangement. The support base supports the first component and the second component in the assembled position while the circulation arrangement circulates liquid from the liquid reservoir through both the first and second components and back to the liquid reservoir.

A heart modeling system according to this second aspect of the invention may include an inferior vena cava component, inferior vena connector arrangement and circulation ports as described above in connection with heart models according to the first aspect of the invention. The rim structures described above for improved sealing between the first and second components according to the first aspect of the invention may also be used in a heart modeling system according to the second aspect of the invention as may the above-described magnet-based connector arrangement.

A third aspect of the present invention encompasses an insert for an anatomical structure model which includes a first component comprising a first part of the anatomical structure and a second component comprising a second part of the anatomical structure. An insert according to this third aspect of the invention includes an insert central portion, an insert peripheral edge structure, and an anatomical target component. The insert peripheral edge structure extends around a periphery of the insert central portion in position to overlap a peripheral edge of the insert receiving passage at least along a portion of the peripheral edge of an insert receiving passage between the first and second components when the insert is in an operating position within the insert receiving passage. The anatomical target component comprises a part of the insert central portion and is located within an area bounded by the insert peripheral edge structure so as to align with the insert receiving passage when the insert is in the operating position.

In some implementations according to this third aspect of the invention the insert peripheral edge structure overlaps the entire peripheral edge of the insert receiving passage and forms a seal with the peripheral edge of the insert receiving passage when the insert is in the operating position within the insert receiving passage. In these and other implementations, the insert central portion may include a peripheral wall extending transverse to a plane of the insert central portion and the peripheral edge structure includes a tab extending from the peripheral wall along the plane of the central portion. This tab is adapted to be captured between the first component and the second component when the insert is in the operating position with respect to the first and second components.

In implementations in which the insert central portion includes a peripheral wall extending transverse to a plane of the insert central portion, the peripheral wall may have a height approximately matching a passage thickness around the periphery of the insert receiving passage when the insert is in the operating position within the insert receiving passage. This matching thickness produces a natural transition (continuity) from the material making up the respective component and the material making up the insert, and thus provides a better representation of the anatomical structure.

Although not limited to such use, an insert according to this third aspect of the invention is particularly suited to represent the interatrial septum of a mammalian heart where the first component comprises a representation of the left atrium of the heart and the second component comprises a representation of the right atrium of the heart. In these implementations the insert central portion comprises a representation of at least a portion of the interatrial septal wall of the heart, and has a first surface facing the first component and a second surface facing the second component when the insert is in the operating position. The anatomical target component in these cases may comprise a representation of the fossa ovalis formed in the second surface of the insert central portion. This application of aspects of the invention is particularly useful for models which may be used in training for procedures which require transseptal puncture in which the fossa ovalis is commonly used as a target or marker for locating the puncture site. Transseptal puncture can be difficult to master and harmful to the patient if performed incorrectly, and having a model which accurately represents the anatomical structure, including the fossa ovalis, allows a practitioner to become proficient at the procedure before performing the procedure on a patient.

These and other advantages and features of the invention will be apparent from the following description of representative embodiments, considered along with the accompanying drawings.

### BRIEF DESCRIPTION OF THE DRAWINGS

FIG. 1 is a view in perspective of an anatomical structure model according to an aspect of the present invention.

FIG. 2 is an exploded view of the model shown in FIG. 1.

FIG. 3 is an enlarged view in right perspective of the insert shown in FIG. 2.

FIG. 4 is an enlarged view in left perspective of the insert shown in FIG. 2.

FIG. 5 is a view in perspective of the right atrium component of the model shown in FIG. 1.

FIG. 6 is a view in perspective similar to FIG. 5 but showing the insert placed over the opening formed in the right atrium component.

FIG. 7 is a view in perspective similar to FIG. 6 but showing the left atrium component placed in the assembled position with the right atrium component and showing the insert in hidden lines in the operating position between the right atrium and left atrium components.

FIG. 8 is a view in perspective of the interatrial septum from inside the right atrium shown in FIG. 7.

FIG. 9 is a view in perspective of the interatrial septum from inside the left atrium shown in FIG. 7.

FIG. 10 is a view in section taken along line 10-10 in FIG. 7

FIG. 11 is a view in perspective of a heart modeling system including the model shown in FIG. 1 connected to a circulation arrangement according to an aspect of the present invention.

### DESCRIPTION OF REPRESENTATIVE EMBODIMENTS

Aspects of the present invention will be described below in connection with an example anatomical structure model and modeling system. The illustrated example anatomical structure model comprises a model of portions of a human heart. As will be described in detail below, this particular example model is particularly suited for use in simulating cardiac procedures involving transseptal puncture. It should be appreciated, however, that the invention is not limited to this particular application and example. Specific examples of other anatomical structures which may be modeled according to the various aspects of the invention will be described below after describing the example shown the figures.

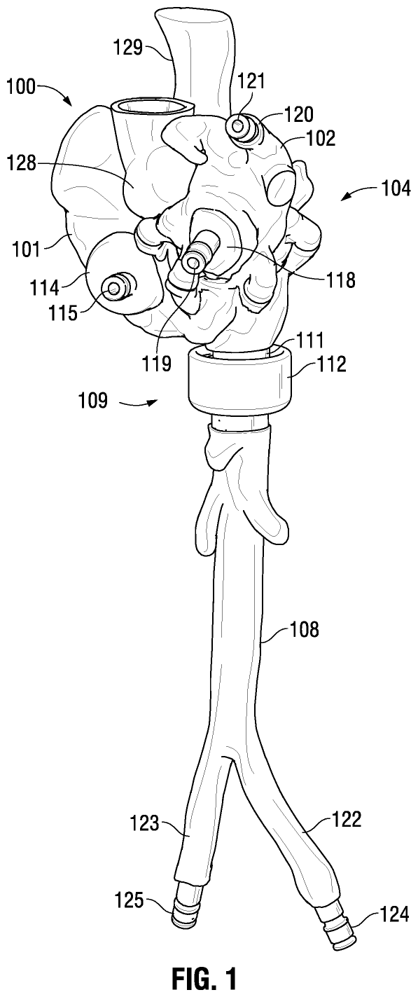

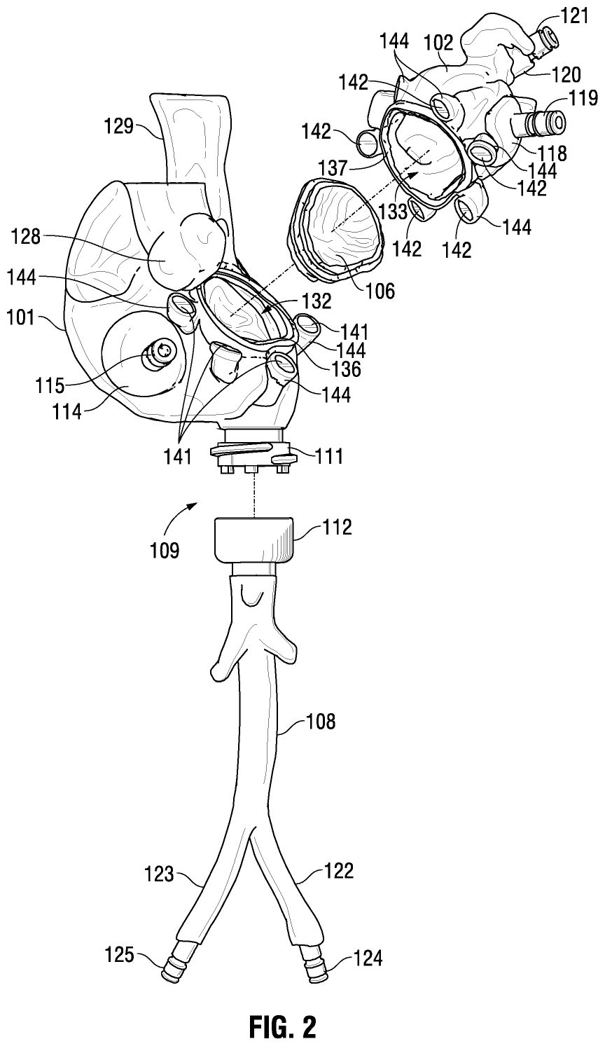

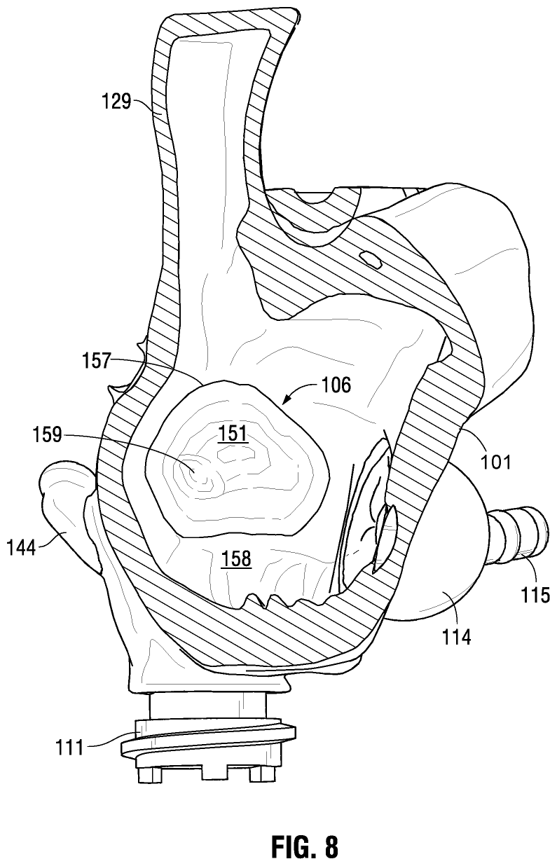

FIG. 1 shows an assembled heart model 100 embodying principles of the invention, while FIG. 2 provides an exploded view of the model. The illustrated model 100 includes a right atrium component 101 connected to a left atrium component 102 through a connector arrangement shown generally at 104 in FIG. 1. As shown in the exploded view of FIG. 2, the model also includes an insert 106. By comparing the assembly of FIG. 1 with the exploded view of FIG. 2, it will be appreciated that insert 106 is located in the assembly essentially between right atrium component 101 and left atrium component 102. In this position in model 100, insert 106 corresponds to a portion of the interatrial septal wall separating the right atrial chamber defined by right atrium component 101 and the left atrial chamber defined by left atrium component 102. As will be described below particularly in connection with FIGS. 4 and 8, insert 106 includes an anatomical target component which comprises a feature representing the fossa ovalis which is commonly used as a marker for locating the puncture point for transseptal puncture.

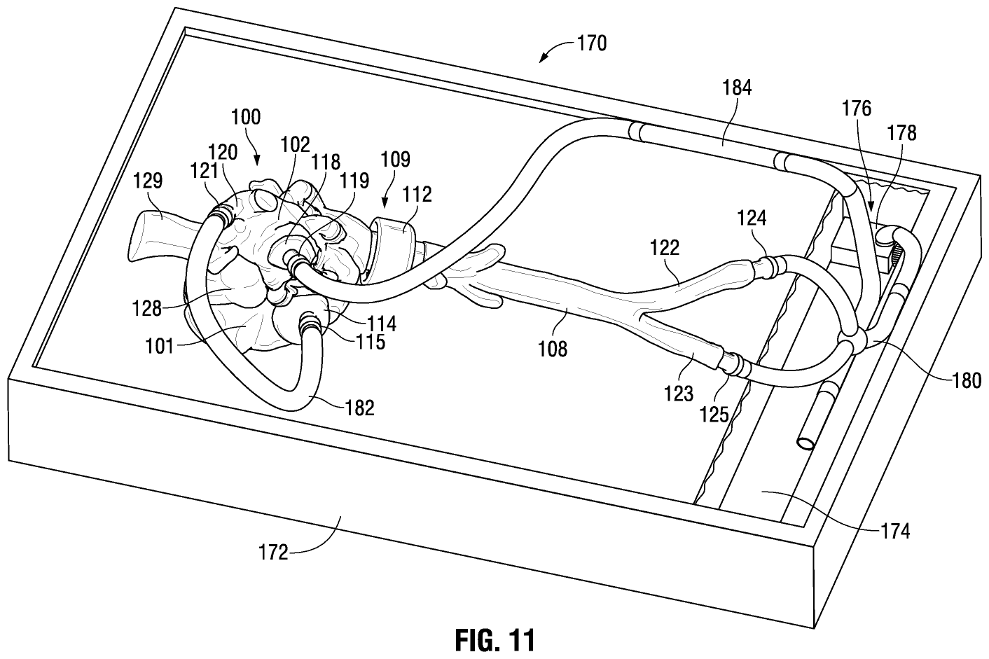

Other components of heart model 100 include a component 108 representing the inferior vena cava and a connecting arrangement 109 connecting the superior vena cava to right atrium component 101. In this case connecting arrangement 109 includes a male connector part 111, which forms part of right atrial atrium component 101, and a female connector part 112 at an upper end of inferior vena cava component 108. The illustrated right atrium component 101 also includes a tricuspid valve dome 114 having a tricuspid valve connector 115. The illustrated left atrium component 102 includes a mitral valve dome 118 with a mitral valve connector 119, and a pulmonary vein representation 120 with a pulmonary vein connector 121. The left and right branches 122 and 123 at the lower part of inferior vena cava component 108 also each include a respective connector 124 and 125. All of these connectors 115, 119, 121, 124, and 125 preferably comprise quick connect-type devices and form part of a liquid circulation arrangement for the illustrated model 100. The other components of this circulation arrangement and operation of the arrangement will be described below in connection with FIG. 11. Additional anatomic features shown in the illustrated model 100 include a portion of the aorta 128 and a representation of the superior vena cava 129 both connected to right atrium component 101.

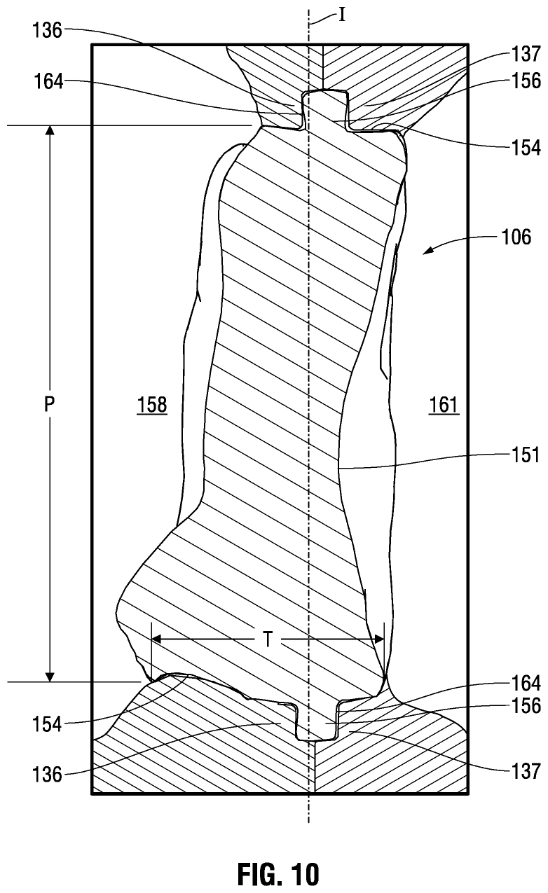

Referring particularly to the exploded view of FIG. 2, each of the right atrium component 101 and left atrium component 102 define a respective component opening. The opening of right atrium component 101 is generally indicated at 132 while the opening of left atrium component 102 in generally indicated at 133. In this example model, right atrium component opening 132 is defined by a first rim structure 136, while left atrium component opening 133 is defined by a second rim structure 137. Further details of these example rim structures will be described below in connection with FIG. 10. As is apparent from FIGS. 1 and 2, and as will be described further below in connection with FIG. 11, when the right atrium and left atrium components 101 and 102, respectively, are placed in the assembled position shown in FIG. 1, the right atrium component opening 132 at least partially aligns with the left atrium component opening 133 to define an insert receiving passage between the right atrium component and left atrium component. Insert 106 is adapted to be received in an operating position covering this insert receiving passage between right atrium component 101 and left atrium component 102. In this operating position with right atrium component 101 and left atrium component 102 in the assembled position, insert 106 presents the surfaces of the majority of the interatrial septal wall as will be described further below.

Connector arrangement 104 (labelled in FIG. 1) shown in the illustrated example includes a number of connecting magnets mounted on each of the right atrium component 101 and left atrium component 102. In particular, a number of first side connecting magnets 141 are mounted on right atrium component 101 in a spaced apart relationship about opening 132 while the number of second side connecting magnets 142 are mounted on left atrium component 102 in a spaced apart relationship about opening 133. First side connecting magnets 141 and second side connecting magnets 142 are spaced about the respective opening so that the magnets on the two components 101 and 102 align when the components are placed in the assembled position shown in FIG. 1. To provide the desired attractive force to connect the two components together in the desired assembled position, first side connecting magnets 141 are mounted in a reverse polarity with respect to second side connecting magnets 142. In this arrangement, as right atrium component 101 and left atrium component 102 are aligned and brought together toward the assembled position, the connecting magnets 141 and 142 attract each other to bring the two components together and hold them together by that attractive force. The particular example shown the figures includes six first side connecting magnets 141 and six corresponding second side connecting magnets 142, however, the invention is not limited to any particular number of connecting magnets. Preferably, three or more connecting magnets on are used on each side (that is, each component) to provide the desire connection. Also, although discrete magnets are shown in the figures, other implementations may use a continuous ring magnet on each component (such as 101 and 102) or magnets forming portions of a ring mounted in locations on the right atrium and left atrium components to align with each other when the components are in the assembled position. In these cases, a single ring magnet, either forming a circular ring or some other shaped ring to fit the given application, may be included on each component (such as 101 and 102) to provide the desired connection. Alternately, a series of elongated magnets may be used as the connecting magnets according to the invention and the elongated magnets oriented in any suitable fashion on the different components such as components 101 and 102 to provide the desired connection.

In order to facilitate the use of connecting magnets 141 and 142 shown in the illustrated example, at least some of the magnets on each component 101 and 102 are each mounted on a respective non-anatomical protuberance 144 formed on the exterior of the respective component. These protuberances 144 are non-anatomical in the sense that they do not simulate any anatomical structure that actually exists in a normal example of the anatomical structure being modeled (in this example case portions of the human heart) but are added to the exterior of the respective component simply to provide a location for a connecting magnet 141 or 142. Since these non-anatomical protuberances 144 are on the outside of the right atrium component 101 and left atrium component 102 of the anatomical structure, the protuberances do not interfere or affect a simulation of a procedure which is carried out within the internal chambers defined by the two components as will be described further below with reference to FIG. 11 in connection with an example procedure using model 100. As will be described below, at least some of the non-anatomical protuberances 144 may be formed together with the adjacent rim structure (136 or 137) from a material different from the remainder of the respective component (101 or 102) and different from other protuberances 144 or magnet-carrying structures. Regardless of whether a connecting magnet 141 or 142 is mounted on a non-anatomical protuberance or otherwise, the magnet may be mounted using adhesives or by friction fit in a receptacle formed on the respective component, or both, or in any other fashion.

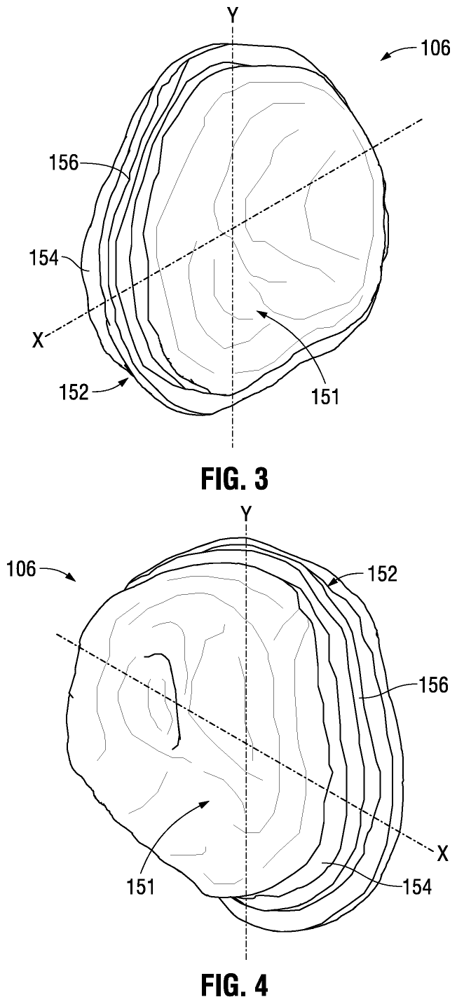

Referring now to FIGS. 3 and 4, insert 106 of the example anatomical structure model 100 includes a central portion 151 and an insert peripheral edge structure shown generally at 152. Peripheral edge structure 152 extends around the entire periphery of insert 106 in an insert central portion plane defined by axes X and Y in FIGS. 3 and 4. In the illustrated example insert 106, insert central portion 151 is bounded by a peripheral wall 154 extending generally transverse to the plane X-Y of the insert central portion. Peripheral edge structure 152 includes a tab 156 extending from peripheral wall 154 along the plane X-Y of the central portion insert central portion. In this position, tab 156 is located so as to be captured between the rim structures 136 and 137 (shown in FIG. 2) of the right atrium component 101 and left atrium component 102, respectively, when insert 106 is in the operating position and the right atrium and left atrium components are placed in the assembled position. The arrangement of tab 156 and wall 154 shown in this example allows the assembly to provide an accurate representation of the internal wall surfaces of the atria as will be described below in connection with FIGS. 8 through 10.

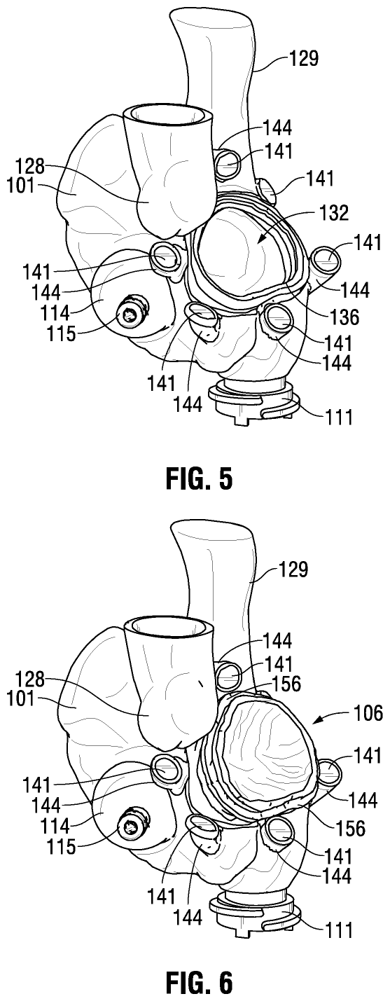

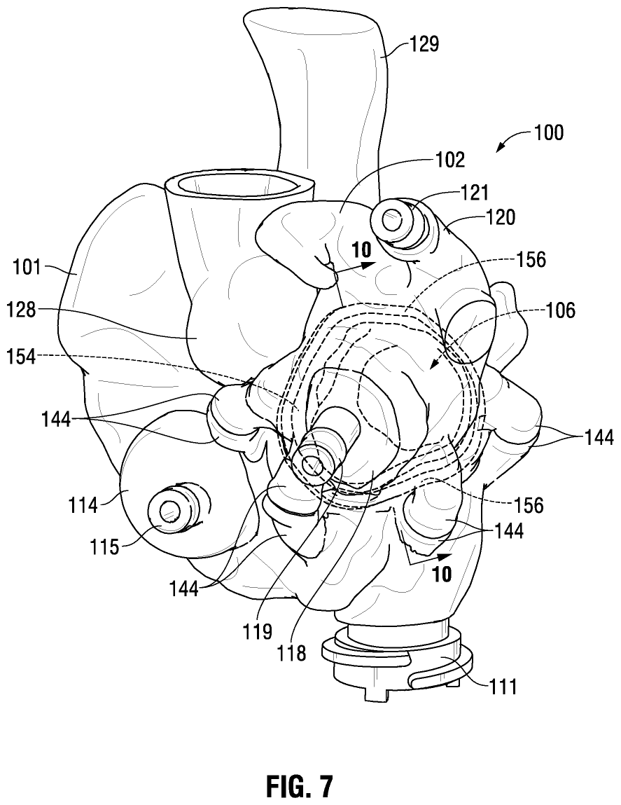

The process of assembling model 100 comprising right atrium component 101, left atrium component 102, connector arrangement 104, and insert 106 may be described in connection with FIGS. 5 through 7. Assembling model 100 includes placing insert 106 in position over opening 132 defined by right atrium component 101 or opening 133 defined by left atrium component 102. In this particular example, FIG. 5 shows right atrium component 101 in an orientation showing opening 132 and rim structure 136, while FIG. 6 shows right atrium component 101 in the same orientation as in FIG. 5 but with insert 106 placed over the right atrium component opening 132 so as to cover the opening. It will be noticed from FIG. 6 that tab 156 of insert 106 comprises the structure defining the insert peripheral edge structure of the insert and overlaps the entire right atrium component opening 132. This allows tab 156 to provide a seal between the right atrium and left atrium components 101 and 102, respectively, as will be described further below. Once insert 106 is placed in the desired position covering component opening 132, the second component, in this case left atrium component 102 can be placed together with right atrium component 101 over the insert. With the magnet-based connecting arrangement employed in this example model 100, once left atrium component 102 is properly aligned with right atrium component 101, the two components can simply be brought together until the attractive force of the magnets 141 and 142 (magnets 142 shown only in FIG. 2) pulls the two components together to the assembled position with the insert remaining in the operating position between the two as shown in FIG. 7. In the view of FIG. 7 insert 106 and its components which are called out are shown in hidden lines since the insert is concealed within the connected components 101 and 102. It should be appreciated that although the example assembly procedure shown in FIGS. 5-7 show insert 106 placed first in the desired position on right atrium component 101, the insert could alternatively be placed over opening 133 of left atrium component 102 first and then right atrium component 101 aligned and placed together with the left atrium component.

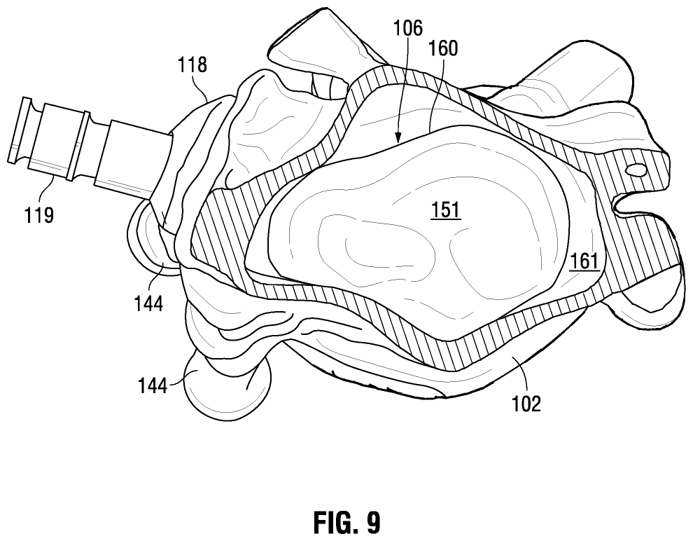

FIGS. 8 and 9 provide views from inside the chambers defined by right atrium component 101 and left atrium component 102, respectively, as they are connected as shown in FIG. 7 (and FIG. 1). FIG. 10 shows a section view through insert 106 generally perpendicular to the plane of insert central portion, which is shown in the figure by line I. As shown in FIG. 8, insert central portion 151 which is shown within the boundary defined by 157 in the figure provides a portion of the surface of right atrial chamber 158 in this example model, and particularly a portion of the surface of the interatrial septal wall facing the right atrial chamber. In this example implementation, insert central portion 151 on this side of the insert shown in FIG. 8 defines a portion of the interatrial septal wall including fossa ovalis 159. Similarly, and as shown in FIG. 9, insert central portion 151 shown within boundary 160 provides a portion of the surface in the left atrial chamber 161, and especially a portion of the interatrial septal wall facing the left atrial chamber. In other words, when insert 106 is received in the operating position, the insert covers the passage defined between components 101 and 102 to complete the anatomical structure as seen from within chambers 158 and 159, defined by components 101 and 102, respectively. As shown best in the section view of FIG. 10, the thickness (dimension T) of the insert receiving passage (dimension P) defined by right atrium component 101 and left atrium component 102 matches the thickness of insert peripheral wall 154. Although this section view of FIG. 10 shows only a single plane, it will be appreciated that this matching thickness preferably extends around the entire periphery of the insert and passage. This matching thickness provides a continuous and realistic surface and representation of the interatrial septum and allows the model 100 according to the present invention to provide a very realistic representation for training purposes.

FIG. 10 also shows how tab 156 comprising the peripheral edge structure of the illustrated insert 106 is captured between rim structure 136 of right atrium component 101 and rim structure 137 of left atrium component 102. These two components 101 and 102 and their respective rim structure 136 and 137 come together to form a tab receiving channel 164 which may be sized in the direction of dimension T so as to provide a desired compression of the material from which the tab is formed and thus provide a good liquid-tight seal between the chambers 158 and 161 defined by right atrium component 101 and left atrium component 102, respectively. This liquid-tight seal also helps provide a realistic simulation since it allows a natural filling of liquid representing blood within the right atrium and left atrium with no unnatural flow between the two.

FIG. 11 shows a modeling system 170 employing the heart model 100 described above in connection with FIGS. 1 through 10. In addition to heart model 100, heart modeling system 170 includes a support base 172, a liquid reservoir 174, and a circulation arrangement shown generally at 176. Support base 172 supports heart model 100 in the position desired for the simulation to be performed, while liquid reservoir 174 and circulation arrangement 176 cooperate to allow a liquid used in the simulation to be circulated through the various internal chambers defined by the model. Circulation arrangement 176 in this example includes a pump 178, inferior vena cava circulation ports defined by connectors 124 and 125, a tricuspid valve circulation port defined by connector 115, a pulmonary vein circulation port defined by connector 121, and a mitral valve circulation port defined by mitral valve connector 119. Inflow tubing 180 connects both of the inferior vena cava connectors 124 and 125 to an output of pump 178. A transfer tube 182 extends from tricuspid valve connector 115 to pulmonary vein connector 121, and a return tube 184 has one end connected to mitral valve connector 119 and an opposite end positioned in liquid reservoir 174. In operation, pump 178 draws liquid from liquid reservoir 174 and directs the liquid through inflow tubing 180 to inferior vena cava component 108. This liquid flows up through inferior vena cava component 108 to right atrium component 101, through transfer tube 182 to left atrium component 102, and then back to reservoir 174 through return tube 184.

Circulation arrangement 176 serves to ensure all of the internal chambers of model 100 are appropriately filled with a liquid which, in this example system, simulates blood. The presence of liquid allows simulated procedures to use standard ultrasonic imaging in the course of the procedure to identify structures within the model and particularly the anatomical target, in this case fossa ovalis 159 (FIG. 8). It will be noted that circulation arrangement 176 does not replicate the actual flow of blood in the heart, but simply provides a way to ensure the internal chambers of the model are full of liquid during the simulated procedure similar to the condition of an actual heart. The direction of flow produced by circulation arrangement is, however, the same direction of flow as an actual heart, and it may be possible to modulate pump 178 to simulate the pulsed flow of a patient's heart.

Use of modeling system 170 may be described in connection with a procedure requiring transseptal puncture. Such procedures may include atrial fibrillation ablation and left atrial appendage occlusion for example. With the modeling system 170 set up as shown in FIG. 11 and liquid circulating through model 100, a procedure simulation may include inserting a catheter (not shown) at a suitable location into inferior vena cava component 108. Although not shown in the example of FIG. 11 a port may be provided in inferior vena cava component 108 for allowing easy access for the catheter. The trainee may then maneuver the catheter up through inferior vena cava component 108 and into right atrium component 101. The procedure involves locating the fossa ovalis (159 in FIG. 8) and manipulating the catheter and cutting instrument to pierce the transseptal wall at a desired point in or adjacent to the area of the fossa ovalis to allow the catheter to be inserted further to reach the chamber defined by left atrium component 102. Throughout this entire process the liquid in the various chambers of model 100 and materials from which the right atrium component 101 and left atrium component 102 are formed allow standard echocardiography equipment to be used to allow the trainee to guide the catheter as required to perform the desired transseptal puncture. When the procedure is complete, the trainee may withdraw the catheter from model 100 and the system may then be drained of liquid. Right atrium component 101 and left atrium component 102 may be separated simply by pulling the two components apart with sufficient force to overcome the magnetic attraction force of connecting magnets 141 and 142. This separation may be done either with the tubing 180, 182, and 184 and inferior vena cava component 108 still connected or otherwise. In any event separating the two atrium components 101 and 102 allows the now pierced insert (106 in FIGS. 2, 3, 4, and 7-10) to be removed and replaced with an intact (unpierced) insert. The model 100 and system 170 may then be reassembled, filled with liquid, and used for another simulation.

The various components of a model and modeling system according to the present invention may be formed from any suitable material or combination of materials. Generally, the materials may be selected to help provide a more realistic simulation in use. This includes compatibility with equipment such as echocardiography equipment which may be used in the simulation to help identify the various structures implicated in the procedure. In the example of heart model 100 described above, atrium components 101 and 102 may be formed from a material such as flexible synthetic polymer blend (such as a polyurethane rubber for example) either by molding or some other manufacturing technique such as three-dimensional printing. Septal wall insert 106 described in the above example may be formed from a blend of natural polymers and silicone. This polymer and silicone material is well suited for transseptal puncture simulation because it can be formulated to closely mimic the reaction of the modeled tissue to the surgical tools which may be used in performing the procedure, including a transseptal puncture needle and catheter. In embodiments where the insert such as insert 106 is captured between components to produce a liquid-tight seal, it may be desirable to produce the rim structure such as 136 and 137 in FIG. 2 from a relatively harder or more rigid material, for example a material exhibiting a higher scale Shore durometer value, than the insert and the surrounding parts of the anatomical components. For example, rim structures 136 and 137 may be formed from a hard acrylic polymer, such as polyacrylamide. In embodiments of the invention using a magnet-based connector arrangement such as that described above, it may also be desirable to form at least some of the non-anatomical protuberances or other structures carrying the magnets from relatively harder or more rigid material as well. In some implementations, the rim structure and some or all of the magnet carrying structure (including protuberances such as 144) may be formed from the same material. These portions of an anatomical component which are formed from a different material than the remainder of the anatomical component may be formed separately from the remainder of the component and then secured to the remainder of the component by suitable means. Alternatively, additive manufacturing processes such as 3D printing may allow all of the given anatomical component (such as 101 or 102 in the above example) to be formed together in a continuous process even though portions of the component (such as rim structures 136 and 137 and protuberances 144) are formed using different materials in the additive manufacturing process. Of course, the invention is not limited to the illustrated magnet-based connector arrangement. Any suitable arrangement may be used to connect the components such as 101 and 102 in the desired assembled position.

The various aspects of the invention encompass numerous variations from the example structure shown in the figures. Fundamentally, although aspects of the invention are well suited for such application, the invention is not limited to modeling the illustrated right and left atria of the heart or any other portions of the heart for that matter. Aspects of the invention may also be applied to simulate portions of other organs that can be divided into components having a common wall or other structure which may be arranged as an insert according to the principles of the invention. With regard to modeling other areas of the heart, a model according aspects of the present invention may include, for example, a right atrium component and a right ventricle component which connect together with an insert that includes all or portions of the tricuspid valve. Such a model may to used to train valve repair procedures for example.

It should also be noted that although the invention is described above in connection with a specific example in which only two components, namely the right atrium component and the left atrium component, come together to form the insert receiving passage, the invention is not limited to only two components. For example, a model according to the present invention may include three or more components which come together to define a complete insert receiving passage in which an insert is received according to the invention. In this case, two of the components may come together to form a portion of the insert receiving passage and one or more additional components may be added to form the remainder of the insert receiving passage. The two components in this arrangement are still placed together in an assembled position to define an insert receiving passage, albeit not the complete insert receiving passage. Also, although the above example insert 106 is adapted to completely cover the insert receiving passage formed between components 101 and 102, an insert may not completely cover an insert receiving passage in other implementations. Rather, the insert in a given implementation of the present invention may only partially cover the insert receiving passage, leaving one or more areas at the periphery of the passage open or uncovered, or one or more areas in the interior of the insert receiving passage open or uncovered.

Other applications of aspects of the invention may include components which each come together to define multiple insert receiving passages and each such passage may receive a respective insert. For example, a heart model may include a right atrium component and left atrium component which forms a septal wall insert receiving passage as in the example shown in the figures, and also include a right ventricle component and a left ventricle component. The right ventricle component may be adapted to be placed in an assembled position with respect to the right atrium component to define an insert receiving passage for receiving an insert which includes a representation of the tricuspid valve. The left ventricle component may be adapted to be placed in an assembled position with respect to the left atrium component to define an insert receiving passage for receiving an insert including a representation of the mitral valve.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, and the like with reference to a given feature are intended only to identify a given feature and distinguish that feature from other features. Unless specifically stated otherwise, such terms are not intended to convey any spatial or temporal relationship for the feature relative to any other feature.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A model of an anatomical structure, the model including:
(a) a first component comprising a first part of the anatomical structure and defining a first component opening;
(b) a second component comprising a second part of the anatomical structure and defining a second component opening, the second component adapted to be placed in an assembled position with the first component in which the second component opening at least partially aligns with the first component opening to define an insert receiving passage between the first component and the second component;
(c) an insert including an insert peripheral edge structure extending around a periphery of the insert, the insert being adapted to be received in an operating position at least partially covering the insert receiving passage between the first component and the second component; and
(d) a connector arrangement for detachably connecting the first component and the second component in the assembled position with the insert in the operating position.

2. The model of claim 1 wherein:
(a) the anatomical structure comprises a mammalian heart;
(b) the first component comprises a left atrium representation;
(c) the second component comprises a right atrium representation;
(d) the insert comprises a representation of a portion of the interatrial septum having a septum wall portion; and
(e) further including an anatomical target component comprising a representation of the fossa ovalis formed in the septum wall portion within an area bounded by the insert peripheral edge structure so as to align with the insert receiving passage and face the right atrium representation when the insert is in the operating position and the first component and second component are in the assembled position.

3. The model of claim 2 further including:
(a) an inferior vena cava component;
(b) an inferior vena cava connector arrangement adapted to connect the inferior vena cava component to the second component; and
(c) one or more circulation ports connected to the inferior vena cava component.

4. The model of claim 3 further including:
(a) a tricuspid valve circulation port connected to a tricuspid valve dome of the second component;
(b) a pulmonary vein circulation port connected to the first component; and
(c) a mitral valve circulation port connected to a mitral dome of the first component.

5. The model of claim 1 further including:
(a) a first rim structure extending around the periphery of the first component opening;
(b) a second rim structure extending around the periphery of the second component; and
(c) wherein the insert peripheral edge structure is received in the operating position by being captured between the first rim structure and the second rim structure.

6. The model of claim 5 wherein the first rim structure, or the second rim structure, or both the first rim structure and the second rim structure are formed from material having a relatively higher hardness than material from which the insert peripheral edge structure is formed.

7. The model of claim 1 wherein:
(a) the insert defines a peripheral wall having a wall thickness approximately matching a thickness of the insert receiving passage around a periphery of the insert receiving passage when the insert is received in the operating position; and
(b) the insert peripheral edge structure comprises a tab extending from the peripheral wall.

8. The model of claim 1 wherein the connector arrangement includes:
(a) three or more first side connecting magnets mounted on the first component in a spaced apart relationship about the first component opening; and
(b) three or more second side connecting magnets mounted on the second component in a spaced apart relationship about the second component opening, each second side connecting magnet being mounted to align with a respective one of the first side connecting magnets in an attracting orientation when the first component and second component are in the assembled position.

9. The model of claim 8 wherein one or more of the first side connecting magnets is mounted on a respective non-anatomical protuberance extending from an exterior surface of the first component, or one or more of the second side connecting magnets is mounted on a respective non-anatomical protuberance extending from an exterior surface of the second component.

10. A heart modeling system including:
(a) a mammalian heart model including:
(i) a first component comprising a representation of a first chamber of a mammalian heart and defining a first component opening,
(ii) a second component comprising a representation of a second chamber of the mammalian heart and defining a second component opening, the second component adapted to be placed in an assembled position with the first component in which the second component opening at least partially aligns with the first component opening to define an insert receiving passage between the first component and the second component,
(iii) an insert including an insert peripheral edge structure extending around a periphery of the insert, the insert being adapted to be received in an operating position at least partially covering the insert receiving passage between the first component and the second component,
(iv) a connector arrangement for detachably connecting the first component and the second component in the assembled position with the insert in the operating position; and
(b) a support base for supporting the first component and the second component in the assembled position;
(c) a liquid reservoir; and
(d) a circulation arrangement for circulating liquid from the liquid reservoir through the first component and back to the liquid reservoir and for circulating liquid from the liquid reservoir to the second component and back to the liquid reservoir.

11. The heart modeling system of claim 10 wherein the first component comprises a left atrium representation and the second component comprises a right atrium representation, and further including:
(a) an inferior vena cava component;
(b) an inferior vena cava connector arrangement adapted to connect the inferior vena cava component to the second component; and
(c) wherein the circulation arrangement includes, one or more circulation ports connected to the inferior vena cava component, a tricuspid valve circulation port connected to a tricuspid valve dome of the second component, a pulmonary vein circulation port connected to the first component, and a mitral valve circulation port connected to a mitral dome of the first component.

12. The heart modeling system of claim 10 further including:
(a) a first rim structure extending around the periphery of the first component opening;
(b) a second rim structure extending around the periphery of the second component opening; and
(c) wherein the insert peripheral edge structure is received in the operating position by being captured between the first rim structure and the second rim structure.

13. The heart modeling system of claim 12 wherein the first rim structure, or the second rim structure, or both the first rim structure and the second rim structure are formed from material having a relatively higher hardness than material from which the insert peripheral edge structure is formed.

14. The heart modeling system of claim 12 wherein:
(a) the insert defines a peripheral wall having a wall thickness approximately matching a thickness of the insert receiving passage around a periphery of the insert receiving passage when the insert is received in the operating position; and
(b) the insert peripheral edge structure comprises a tab extending from the peripheral wall.

15. The heart modeling system of claim 10 wherein the connector arrangement includes:
(a) three or more first side connecting magnets mounted on the first component in a spaced apart relationship about the first component opening; and
(b) three or more second side connecting magnets mounted on the second component in a spaced apart relationship about the second component opening, each second side connecting magnet being mounted to align with a respective one of the first side connecting magnets in an attracting orientation when the first component and second component are in the assembled position.

16. An insert for a model of an anatomical structure, the insert adapted to cooperate with a first component comprising a first part of the anatomical structure and a second component comprising a second part of the anatomical structure, the second component being adapted to be placed in an assembled position with the first component to define an insert receiving passage between the first component and second component, the insert including:
(a) an insert central portion;
(b) an insert peripheral edge structure extending around a periphery of the insert central portion in position to overlap a peripheral edge of the insert receiving passage at least along a portion of the peripheral edge of the insert receiving passage when the insert is in an operating position within the insert receiving passage; and
(c) an anatomical target component, the anatomical target component comprising a part of the insert central portion and being located within an area bounded by the insert peripheral edge structure so as to align with the insert receiving passage when the insert is in the operating position.

17. The insert of claim 16 wherein the insert peripheral edge structure overlaps the entire peripheral edge of the insert receiving passage and forms a seal with the peripheral edge of the insert receiving passage when the insert is in the operating position within the insert receiving passage.

18. The insert of claim 17 wherein:
(a) the insert central portion includes a peripheral wall extending transverse to a plane of the insert central portion; and
(b) the insert peripheral edge structure includes a tab extending from the peripheral wall along the plane of the central portion, the tab adapted to be captured between the first component and the second component when the first component and second component are in the assembled position and the insert is in the operating position.

19. The insert of claim 16 wherein the insert receiving passage defines a passage thickness extending along the periphery of the insert receiving passage, and wherein the insert central portion includes a peripheral wall extending transverse to a plane of the insert central portion, the peripheral wall having height approximately matching the passage thickness around the periphery of the insert receiving passage when the insert is in the operating position within the insert receiving passage.

20. The insert of claim 16 wherein the first component comprises a representation of the left atrium of a mammalian heart and the second component comprises a representation of the right atrium of the mammalian heart and wherein:
(a) the insert central portion comprises a representation of at least a portion of the interatrial septal wall of the mammalian heart, and has a first surface facing the first component and a second surface facing the second component when the insert is in the operating position; and
(b) the anatomical target component comprises a representation of the fossa ovalis formed in the second surface of the insert central portion.
